(19) United States
(12) Patent Application Publication
(10) Pub. No.: US 2007/0140811 A1
(43) Pub. Date: Jun. 21, 2007

(54) High strength screw head and driver bit

(76) Inventor: Bruce Hoyt, Bolingbrook, IL (US)

Correspondence Address: Allan J. Franowsky, 362 Grape Vine Trail, Oswego, IL, 60543, US

(21) Appl. No.: 11/304,222

(22) Filed: Dec. 15, 2005

(51) Int. Cl. F16B 23/00; F16B 35/06; B25B 15/00; B25B 23/00; B25B 13/48

(52) U.S. Cl. 411/402; 81/436; 81/460; 411/403; 411/919

(57) ABSTRACT

A screw and corresponding driver bit with a rectangular slot formed in the head of the screw. The rectangular slot leaves more head material on the surface of the screw head compared to a conventional slotted screw which divides the surface into two sections. The rectangular slot provides greater screw head surface strength. The rectangular slot extends relatively deeply toward the shank of the screw to provide a large surface to receive the torque of the driver bit. The two larger surfaces of the slot are essentially parallel to each other to eliminate the tendency of the driver bit to ride up and out of the slot. This greatly reduces the pressure needed to engage and maintain the driver in the slot.

### BACKGROUND OF THE INVENTION

1. Field of the Invention

This invention generally pertains to common screw fasteners in all of their possible slot configurations. Specifically, this invention provides a high strength screw head slot design in combination with a corresponding driver bit that provides higher resistance to stripping compared to other common screws.

2. Description of the Prior Art

It is well known that machine screws, wood screws, self tapping, and self drilling screws can come in a variety of head types. With the appropriate driving bit, the screw can be rotated on its axis. The slot or aperture in the head can have any number of popular configurations, such as a near circular multi-sided arrangement, a six-sided allen slot or star type, a four-sided type, called a square drive, among others. Those with experience know that as the slot gains more sides and approaches a circle with many short flat sides, it becomes easier to strip out as torque is applied to the screw. The stripping is not limited just to the screw, however. The driving bit itself can become rounded out and lose its multiple flat sided features and therefore unable to rotate the screw. Often the stripping is mutually divided between both the slot in the head and the driving bit. From this analysis, one can conclude that the six-sided allen screw would likely strip easier than the four-sided square drive.

Two other head types are common. One is the straight slotted screw and the other is the phillips head. A standard straight slot screwdriver used in a straight slot head can easily slide along the slot until it slips completely off the screw head, making it likely to mar the surface adjacent to the head. Further, not much head material supports the slot, which is easily sheared off as torque is applied. Often the straight slot is so shallow, that a stripped head is more likely than not.

A phillips head has two slots, each at a right angle to the other, both having the same length, each length being less than the diameter of the head itself. A frequent problem with applying torque to a phillips head, is that as one increases the torque, more pressure has to be applied to the head of the screw to remain inside the slots, otherwise the phillips screwdriver tip will ride up out of the slot and fall into the next slot, thereby eventually stripping the slots so that torque can no longer be applied to the head of the screw. The torque required to advance the screw into a material increases as the screw advances. Therefore, the possibility of stripping a phillips screw head increases as the screw advances. This problem is especially severe when using a powered screw driver because the high torque of a powered screw driver can easily strip the head if increased pressure is not applied to the screw.

U.S. Pat. No. 386,092 to C. D. Rogers is a screw with an elongated slot with rounded slot ends. The relative shallowness of the screw slot is only made worse if the ordinary screwdriver does not fully engage the bottom of the slot. Then the screwdriver will ride up and rest against the rounded slot ends, engaging less of the flat walls when torque is applied. This is an easy screw to strip. U.S. Pat. No. 2,058,197 to M. A. West is a screw that represents a slot with a circular aperture at the bottom center of the slot. The driver bit is shaped to engage the slot and aperture simultaneously. The slot is relatively shallow with a relatively small surface area, and the circular aperture does not provide additional means to transfer torque. This screw could strip easily. U.S. Pat. No. 2,322,509 to De Vellier is a screw with a six-sided somewhat shallow slot. This screw could strip easily also. U.S. Pat. No. 2,386,629 to E. W. North et al. for a hose clamp reveals a slot with a separate ring around the screw that does not provide additional structural integrity to the screw itself. U.S. Pat. No. 2,833,325 to Laisy is a countersunk flexible head threaded fastener which in all its embodiments depicted in the drawings demonstrates relatively shallow slots. U.S. Pat. No. 3,293,978 to Handley is a screw with a v-shaped slot.. This greatly reduces the surface area that can transfer torque. Further, a conventional screwdriver would not effectively engage this slot at all. U.S. Pat. No. 3,456,548 to E. D. Schmidt et al. is a screw with hexagonal-collared slotted head. The slot is relatively narrow and the collar is not part of the structure of the face of the screw. U.S. Pat. No. 5,269,209 to Baker is a curvilinear drive screwdriver and screw. This slot is shallow and does not provide full face contact. It is intended to allow for misalignment, rather than providing structural strength.

The need exists for a screw having a relatively deep slot, yet preserving the surface strength of the screw head. Such a screw with its mating driver bit would be strong, non stripping, non slipping and, in some instances, capable of being driven by a conventional screwdriver. A

### SUMMARY OF THE INVENTION

An object of this invention is to reduce the force required to hold a driver bit in the slot of a screw head compared to the force required to hold a driver in a phillips head screw slot.

Another object of this invention is to provide for large flat driving surfaces in the slot that reduce the tendency of the driver bit to ride up and out of the slot. This feature reduces the tendency to strip the screw head compared to both a phillips head screw and a straight slotted head screw.

A further object of this invention is to provide for a slot design that leaves more screw head material intact resulting in stronger screw head strength, and therefore provides greater resistence to stripping compared to a straight slotted head screw where the slot effectively divides the screw head into two surfaces.

The present invention provides for a rectangular slot formed in the head of a screw. This slot extends deeply toward the shank of the screw maintaining enough material between the surfaces inside the slot and the outside surfaces of the screw head so as to not compromise the strength of the screw head. For a screw head with a conical surface, the two smaller surfaces inside the slot would taper toward each other at the shank end allowing enough material to remain to maintain the strength between those surfaces and the outside surface of the screw head. The two larger slot surfaces against which the torque is applied are essentially parallel to each other so that there is no ramping effect that would tend to cause the driver bit to ride up and out of the slot. The corresponding bit driver in the present invention has substantially the same dimensions at its driving tip as does the slot. This provides for a positive engagement of the bit driver in the slot.

### BRIEF DESCRIPTION OF THE DRAWINGS

FIG. 1 illustrates an isometric view of a conical head screw with a rectangular slot extending from the surface of the screw head toward the shank end of the screw.

FIG. 2 illustrates a sectional view taken along the line II-II in FIG. 1.

FIG. 3 illustrates a sectional view taken along the line III-III in FIG. 1.

FIG. 4 illustrates a side view of a driver bit for a conical head screw.

FIG. 5 illustrates the orthogonal side view of the driver bit in FIG. 4 for a conical head screw.

FIG. 6 illustrates an isometric view of a cylindrical head screw with a rectangular slot extending from the surface of the screw head toward the shank end of the screw.

FIG. 7 illustrates a sectional view taken along the line VII-VII in FIG. 6.

FIG. 8 illustrates a sectional view taken along the line VIII-VIII in FIG. 6.

FIG. 9 illustrates a side view of a driver bit for a cylindrical head screw.

FIG. 10 illustrates the orthogonal side view of the driver bit in FIG. 9 for a cylindrical head screw.

### DETAILED DESCRIPTION OF THE INVENTION

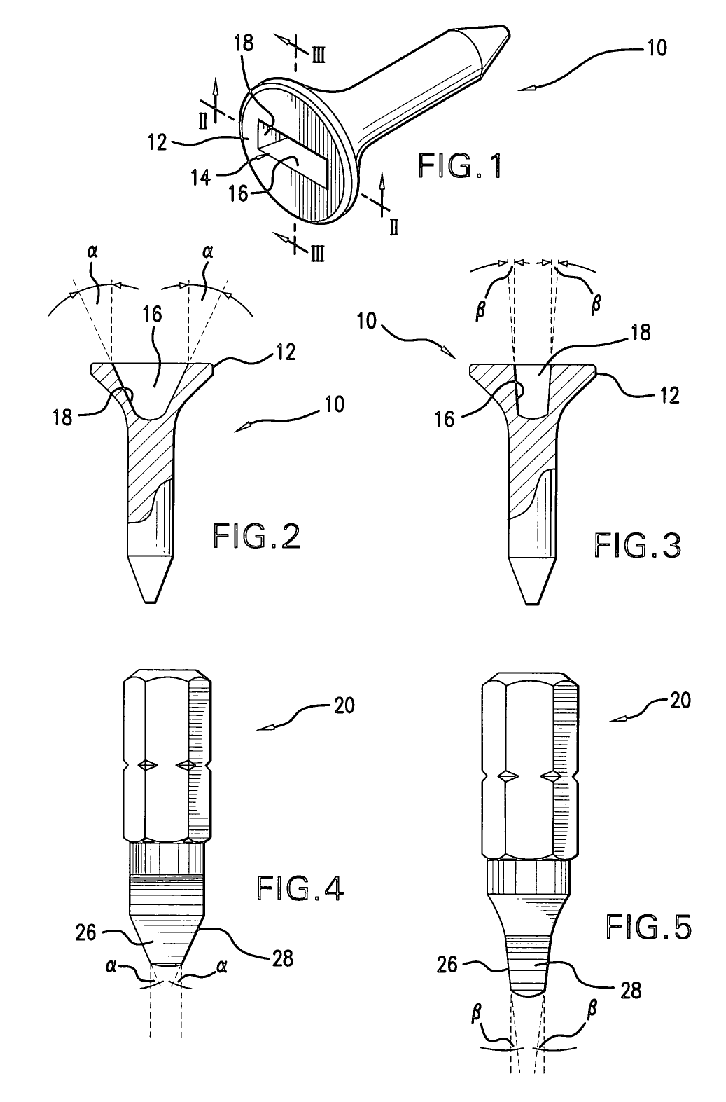

FIG. 1 illustrates an isometric view of a conical head screw 10 with a conical head 12 and a rectangular slot 14. As the rectangular slot 14 extends toward the shank of the conical head screw 10, two larger surfaces 16 and two smaller surfaces 18 define the boundaries of the slot 14. FIG. 2 illustrates a sectional view taken along the line II-II of conical head screw 10 in FIG. 1. Smaller surfaces 18 are flat surfaces that subtend an angle α with respect to a line parallel to the axis of the shank of conical head screw 10. The angle α can vary between zero degrees and twenty five degrees. The distance between the smaller surfaces 18 and the outside surfaces of the conical head 12 should be no less than 10% of the depth of the slot 14 measured from the surface of the conical head 12 to the bottom of the slot at the shank end. This distance serves to insure the structural integrity of the conical head 12.

FIG. 3 illustrates a sectional view taken along the line III-III of conical head screw 10 in FIG. 1. Lines II-II and III-III are perpendicular to each other. Larger surfaces 16 are flat surfaces that subtend an angle β with respect to a line parallel to the axis of the shank of conical head screw 10. The angle β can vary between zero degrees to no more than five degrees. At zero degrees, the larger surfaces 16 would be parallel to each other. The advantage of this relatively small angle β is that the driver bit illustrated in FIG. 4 and FIG. 5 would have a reduced tendency to ramp up and ride out of the slot 14 when torque is applied to advance the conical head screw 10. As the conical head screw 10 advances into a material, increasing torque must be applied to advance the conical head screw 10 further into the material. The larger surfaces 16 also provide more frictional contact area for the driver bit illustrated in FIG. 4 and FIG. 5. The friction increases as the torque increases, thereby making it even more unlikely that the driver bit illustrated in FIG. 4 and FIG. 5 would ride up and out of the slot 14. In addition, the relatively large surface area of the larger surfaces 16 permits a greater turning force, or torque, to occur against the larger surfaces 16 lessening the chances of stripping the slot 14 with the driver bit illustrated in FIG. 4 and FIG. 5. The driver bit illustrated in FIG. 4 and FIG. 5 has larger surfaces 26 and smaller surfaces 28 to engage the larger surfaces 16 and smaller surfaces 18 respectively when inserted in slot 14. The angle α in FIG. 4 represents the angle between the smaller surfaces 28 and a line parallel to the axis of the driver bit. This angle α is the same in both FIG. 4 and FIG. 2 and can vary between zero degrees and twenty five degrees. The angle β in FIG. 5 represents the angle between the larger surfaces 26 and a line parallel to the axis of the driver bit. This angle β is the same in both FIG. 5 and FIG. 3 and can vary between zero degrees and no more than five degrees.

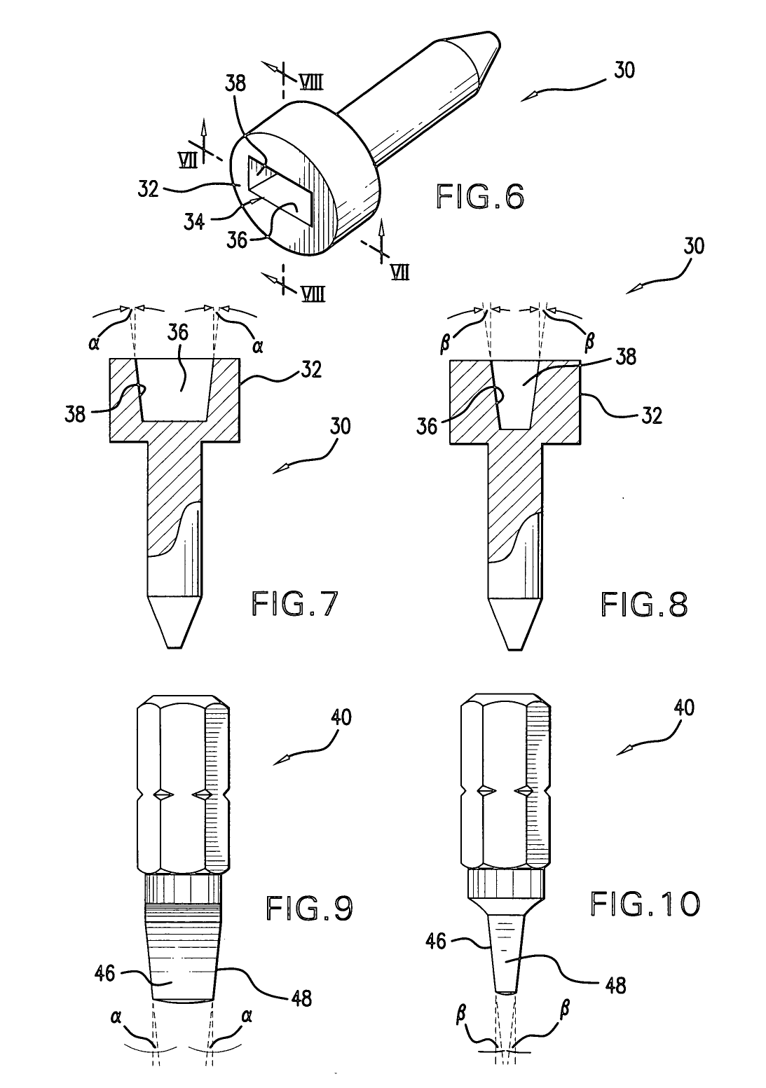

FIG. 6 illustrates an isometric view of a cylindrical head screw 30 with a cylindrical head 32 and a rectangular slot 34. As the rectangular slot 34 extends toward the shank of the cylindrical head screw 30, two larger surfaces 36 and two smaller surfaces 38 define the boundaries of the slot 34. FIG. 7 illustrates a sectional view taken along the line VII-VII of cylindrical head screw 30 in FIG. 6. Smaller surfaces 38 are flat surfaces that subtend an angle α with respect to a line parallel to the axis of the shank of cylindrical head screw 30. This angle α can vary between zero degrees and five degrees. The cylindrical head screw 30 by virtue of its geometry is a more rugged screw than the conical head screw 10 described above and can be used in more demanding environments.

FIG. 8 illustrates a sectional view taken along the line VIII-VIII of cylindrical head screw 30 in FIG. 6. Lines VII-VII and VIII-VIII are perpendicular to each other. Larger surfaces 36 are flat surfaces that subtend an angle β with respect to a line parallel to the axis of the shank of the cylindrical head screw 30. The angle β can vary between zero degrees to no more than five degrees. At zero degrees, the larger surfaces 36 would be parallel to each other. Once again, in this type of screw, the advantage of this relatively small angle β is that the driver bit illustrated in FIG. 9 and FIG. 10 would have a reduced tendency to ramp up and ride out of the slot 34 when torque is applied to cylindrical head screw 30. The same features describing the reduced chances of stripping the slot 14 described for the conical head screw 10 also apply for slot 34 here. The driver bit illustrated in FIG. 9 and FIG. 10 has larger surfaces 46 and smaller surfaces 48 to engage the larger surfaces 36 and smaller surfaces 38 respectively when inserted in slot 34. The angle α in FIG. 9 represents the angle between the smaller surfaces 48 and a line parallel to the axis of the driver bit illustrated. This angle α is the same in both FIG. 9 and FIG. 7 and can vary between zero degrees and five degrees. The angle β in FIG. 10 represents the angle between the larger surfaces 46 and a line parallel to the axis of the driver bit. This angle β is the same in both FIG. 10 and FIG. 8 and can vary between zero degrees to no more than five degrees. These two screws, the conical head screw 10 and the cylindrical head screw 30, describe a general use screw and heavy duty use screw respectively, but any screw head variation is possible depending on the intended application of the screw. The foregoing description of a preferred embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

I claim:

1. A screw having a head and a shank in combination with a corresponding driver bit comprising:
a. a rectangular slot in the head extending relatively deeply into the head toward the shank; and
b. a driver bit having a tip with substantially the same dimensions as the rectangular slot.

2. (canceled)

3. The rectangular slot of claim 1 wherein the slot defines two larger surfaces of equal area, the two surfaces essentially parallel to each other.

4. (canceled)

5. The rectangular slot of claim 1 wherein the slot defines two smaller surfaces of equal area.

6. (canceled)

7. The rectangular slot of claim 1 wherein the distance between each of the smaller surfaces of the slot and the outside surface of the screw head is no less than 10 percent of the depth of the slot as it extends relatively deeply into the head toward the shank, measured from the outside surface of the screw head to the bottom of the slot at the shank end.
